(19) United States
(12) Patent Application Publication
(10) Pub. No.: US 2010/0018817 A1
(43) Pub. Date: Jan. 28, 2010

(54) Engine Mount

(75) Inventors: Jeong Hoon KIM, Seoul (KR); Jae Yong Choi, Busan (KR)

Correspondence Address: MORGAN, LEWIS & BOCKIUS LLP (SF), One Market, Spear Street Tower, Suite 2800, San Francisco, CA, 94105, US

(73) Assignees: Hyundai Motors Company, Seoul (KR); Daeheung R&T Co., LTD., Gimhae-si (KR)

(21) Appl. No.: 12/506,159

(22) Filed: Jul. 20, 2009

(30) Foreign Application Priority Data
Jul. 25, 2008 (KR) 10-2008-0073113

(51) Int. Cl. F16F 9/10

(52) U.S. Cl. 188/269

(57) ABSTRACT

A pneumatic active engine mount has a middle fluid chamber and a pneumatic chamber inside an orifice module using a pneumatic plate. The orifice module divides an inner space in which working fluid is encapsulated into an upper fluid chamber and a lower fluid chamber. A change in the air pressure of the pneumatic chamber causes a change in the pressure of the middle chamber to thereby introduce a flow of working fluid between the upper fluid chamber and the middle fluid chamber. Various frequencies of vibration in an engine of a vehicle are reduced, and in particular, engine vibration in a middle-to-idling range is actively reduced.

### CROSS-REFERENCE TO RELATED APPLICATION

The present application claims priority to Korean Patent Application No. 10-2008-0073113 filed on Jul. 25, 2008, the entire contents of which is incorporated herein for all purposes by this reference.

### BACKGROUND OF THE INVENTION

1. Field of the Invention

The present invention relates to a pneumatic active engine mount. More particularly, the present invention relates to a pneumatic active engine mount, which can reduce various frequencies of vibration in an engine of a vehicle and, in particular, actively reduce engine vibration in a middle-to-idling range by forming a middle fluid chamber and a pneumatic chamber inside an orifice module using a pneumatic plate, the orifice module dividing an inner space in which working fluid is encapsulated into an upper fluid chamber and a lower fluid chamber, such that a change in the air pressure of the pneumatic chamber causes a change in the pressure of the middle chamber to thereby introduce a flow of working fluid between the upper fluid chamber and the middle fluid chamber.

2. Description of Related Art

An engine in a vehicle is a sort of power source. The engine is mounted on a body of a vehicle using a medium referred to as an engine mount to reduce vibration and resultant noise generated in the engine before they are transmitted to the body of the vehicle.

In general, a small-gasoline engine vehicle uses a bush-type engine mount made of rubber, and both a large-gasoline engine vehicle and a diesel engine vehicle use a hydraulic engine mount in which fluid is encapsulated. However, such a passive engine mount as described above cannot reduce all types of vibration and noise across all variable operating ranges considering its structure.

Generally, when vibration is generated by an engine, features of vibration in idling and low-speed running are different from those in high-speed running. Thus, an engine mount is required to have different levels of dynamic stiffness for the idling and low-speed running as well as for the high-speed running. Specifically, a high dynamic stiffness is required for the idling and low-speed running, and a low dynamic stiffness is required for the high-speed running. Describing in relation with frequencies of vibration generated by the engine, frequency ranges can be divided into a shaking range in which low-frequency vibration occurs with a large displacement, an idling range in which intermediate-frequency vibration occurs with a middle displacement and a booming range in which high-frequency vibration occurs with a small displacement. To achieve more excellent vibration reducing effects, the engine mount is required to have different levels of dynamic stiffness according to the different frequency ranges.

However, neither the bush-type engine mount nor the fluid-filled hydraulic engine mount as described above has vibration-reducing functions in all the variable operating ranges. To cope with these problems, an active engine mount capable of being controlled for all variable frequency ranges of vibration in the engine is recently under development.

A typical active engine mount generally is constructed based on a direct electronic control technique, and includes a vibration-generating device installed inside the engine mount in order to reduce vibration. The vibration-generating device reduces vibration in the engine by generating a wave having the same waveform as the vibration in the engine by electronically controlling for example an elastic body. However, this type of active engine mount has problems such as an increased number of parts, a difficult assembly process, an increased manufacturing cost and an increase in the size of the engine mount.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a pneumatic active engine mount, which can reduce various frequencies of vibration in an engine of a vehicle and, in particular, actively reduce engine vibration in a middle-to-idling range by forming a middle fluid chamber and a pneumatic chamber inside an orifice module using a pneumatic plate, the orifice module dividing an inner space in which working fluid is encapsulated into an upper fluid chamber and a lower fluid chamber, such that a change in the air pressure of the pneumatic chamber causes a change in the pressure of the middle chamber to thereby introduce a flow of working fluid between the upper fluid chamber and the middle fluid chamber.

In an aspect of the present invention, the engine mount may include a main rubber and a diaphragm coupled with an upper portion and a lower portion of a tubular body, respectively, to define a first inner space in which working fluid is encapsulated, upper and lower orifice plates coupled with each other to define a second inner space therein, the upper and lower orifices being disposed in the first inner space and connected to the tubular body to define an upper fluid chamber between the main rubber and the upper orifice plate and defining a lower fluid chamber between the lower orifice plate and the diaphragm, a pneumatic plate disposed inside the second inner space and dividing the second inner space into a middle fluid chamber in which the working fluid selectively communicates between the upper fluid chamber and the middle fluid chamber through a sub-orifice channel formed in the upper orifice plate, and a pneumatic chamber to which a pressure is applied to control a pressure therein, and a main orifice channel formed in the upper and lower orifice plates and configured to allow fluid communication between the upper fluid chamber and the lower fluid chamber, whereby inertial resistance of the working fluid passing through the main orifice and inertial resistance of the working fluid passing through the sub-orifice reduce vibration in an engine.

The pneumatic plate may be press-fitted into the upper orifice plate to form an assembly of the upper orifice plate and the pneumatic plate, which is in turn press-fitted into the lower orifice plate.

The inertial resistance of the working fluid passing through the main orifice channel and the inertial resistance of the working fluid passing through the sub-orifice channel may reduce different vibration frequencies of the engine.

In another aspect of the present invention, the engine mount may further include a control device for controlling the pressure in the pneumatic chamber, wherein the pneumatic plate is configured and dimensioned to be deformed in response to a change in the pressure of the pneumatic chamber caused by the control unit such that the working fluid is introduced to selectively communicate between the upper fluid chamber and the middle fluid chamber, wherein the control unit includes an air channel formed in the lower orifice plate, for allowing air to enter and exit the pneumatic chamber, and a solenoid valve for opening and closing the air channel.

The solenoid valve may operate on a signal, received from an electronic control unit of the vehicle, in order to operate according to vibration states of the engine.

According to various aspects of the present invention, the pneumatic active engine mount can reduce various frequencies of vibration in an engine of a vehicle and, in particular, actively reduce engine vibration in a middle-to-idling range by forming a middle fluid chamber and a pneumatic chamber inside an orifice module using a pneumatic plate, the orifice module dividing an inner space in which working fluid is encapsulated into an upper fluid chamber and a lower fluid chamber, such that a change in the air pressure of the pneumatic chamber causes a change in the pressure of the middle chamber to thereby introduce a flow of working fluid between the upper fluid chamber and the middle fluid chamber.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic cross-sectional view illustrating an exemplary engine mount according to the present invention.

FIGS. 2A and 2B are configuration views illustrating operational states of the engine mount shown in FIG. 1.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

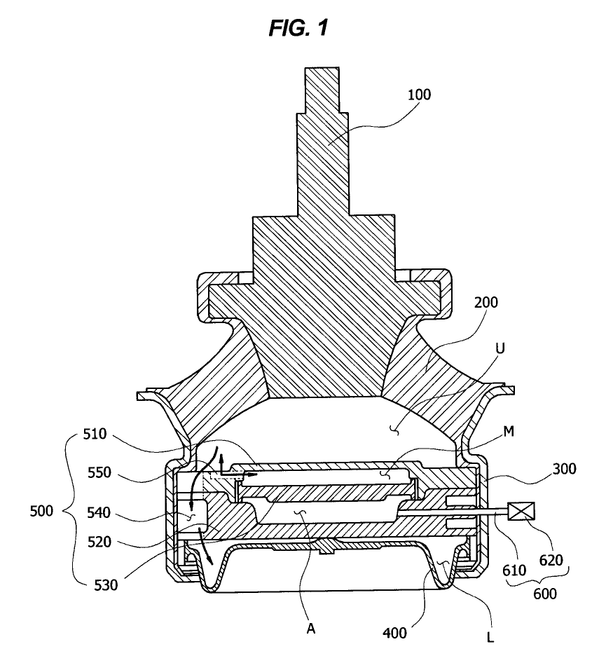

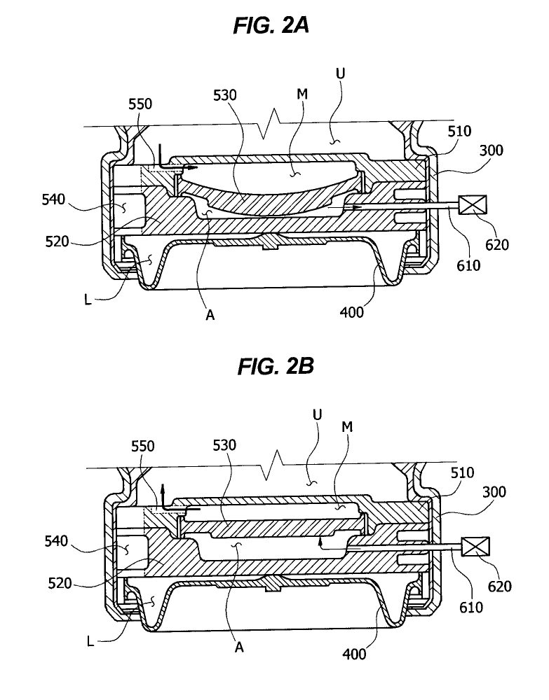

FIG. 1 is a schematic cross-sectional view illustrating an engine mount according to various embodiments of the present invention, and FIGS. 2A and 2B are configuration views illustrating operational states of the engine mount shown in FIG. 1.

As shown in FIG. 1, the engine mount according to various embodiments of the present invention is constructed such that working fluid is encapsulated in an inner space defined by a main rubber 200 and a diaphragm 400, with the main rubber 200 coupled to the upper portion of a hollow tubular body or main pipe 300 and with the diaphragm 400 coupled to the lower portion of the main pipe 300. An orifice module 500 installed in the inner space is divided into an upper fluid chamber U and a lower fluid chamber L, which communicate with each other. In addition, a center bolt 100 is fitted and coupled into the main rubber 200, for example, by curing bonding in such a manner that it can be coupled with an engine of a vehicle.

As shown in FIG. 1, the orifice module 500 includes upper and lower orifice plates 510 and 520 and a pneumatic plate 530, wherein the pneumatic plate 530 divides an inner space, defined by coupling between the upper and the lower orifices 510 and 520, into a middle fluid chamber M filled with working fluid and a pneumatic chamber A to which air pressure is applied. A main orifice channel 540 is formed in the upper and lower orifice plates 510 and 520 such that the upper fluid chamber U and the lower fluid chamber L communicate with each other. A sub-orifice channel 550 is formed in the upper orifice plate 510 such that the upper fluid chamber U and the middle orifice chamber M communicate with each other. The upper and lower orifice plates 510 and 520 and the pneumatic plate 530 are assembled together by press-fitting the pneumatic plate 530 into the upper orifice plate 510 and then press-fitting an assembly of the upper orifice plate 530 and the pneumatic plate 530 into the lower orifice plate 520. Through these procedures, an assembly process can be further facilitated.

In the engine mount constructed as above, when the engine vibrates, the main rubber 200 is deformed by the center bolt 100 coupled with the engine, causing a change in the pressure of the upper fluid chamber U. The change in the pressure drives working fluid encapsulated in the upper fluid chamber U to flow into the lower fluid chamber L or the middle fluid chamber M through the main orifice channel 540 and the sub-orifice channel 550. Here, inertial resistance of the working fluid acts to reduce the vibration in the engine.

The engine mount according to various embodiments of the present invention can preferably be constructed to reduce different frequencies of vibration in the engine using the inertial resistance of the working fluid passing through the main orifice channel 540 and through the sub-orifice channel 550. For example, the engine mount can be constructed such that the inertial resistance of the working fluid passing through the main orifice channel 540 acts to reduce low frequency vibration in the engine and the inertial resistance of the working fluid passing through the sub-orifice channel 550 acts to reduce middle-to-idling frequency vibration in the engine. Here, the individual procedures can be carried out independently.

The pneumatic plate 530 can be preferably made of a soft material such as rubber such that it can be easily deformed in response to a change in the pressure of the pneumatic chamber A. The air pressure of the pneumatic chamber A can be constructed in such a manner that it can be controlled by a separate control device 600 according to various embodiments of the present invention. Therefore, when the air pressure of the pneumatic chamber A is changed by the control device 600, the pneumatic plate 530 is deformed and thus the volume of the middle fluid chamber M is changed to cause a change in pressure. This change makes the pressure of the middle chamber M different from that of the upper fluid chamber U such that the working fluid flows into the space of the upper fluid chamber U or the middle fluid chamber M through the sub-orifice channel 550.

When the pneumatic chamber A has a negative pressure, the pneumatic plate 530 is deformed downwards, as shown in FIG. 2A, to increase the space of the middle fluid chamber M, thereby decreasing the pressure of the middle fluid chamber M. Then, the working fluid flows from the upper fluid chamber U through the sub-orifice channel 550 into the middle chamber M. In contrast, when the pneumatic chamber A has a positive pressure (which can be the atmospheric pressure higher than the pressure of the middle fluid chamber M), the pneumatic plate 530 returns to the original position, as shown in FIG. 2B, or is deformed upwards to decrease the space of the middle fluid chamber M, thereby increasing the pressure of the middle fluid chamber M. Then, on the contrary to FIG. 2A, the working fluid flows from the middle fluid chamber M through the sub-orifice channel 550 into the upper fluid chamber U.

According to the above-described construction, the engine mount according to various embodiments of the present invention can actively reduce vibration in the engine by changing the air pressure of the pneumatic chamber A using the control device 600 so that the working fluid is caused to flow between the upper fluid chamber U and the middle fluid chamber M through the sub-orifice channel 550.

The control device 600 includes an air channel 610 defined in the lower orifice plate 520, for allowing air to enter and exit the pneumatic chamber A, and a solenoid valve 620 for opening and closing the air channel 610 according to various embodiments of the present invention. The control device 600 can control the period of changing the air pressure of the pneumatic chamber A according to various frequencies in order to actively reduce vibration in the engine.

Here, the solenoid valve 620 can be constructed to operate on a signal, received from an Electronic Control Unit (ECU) of a vehicle, in order to operate according to vibration frequencies of the engine. The solenoid valve 620 can be controlled by applying a pulse-type drive signal to the solenoid valve 620, in consideration of a duty ratio and engine vibration timing together with control signal timing, negative pressure timing, timing when the pneumatic plate is deformed and timing when the middle chamber is deformed by the pressure.

Accordingly, the engine mount of various embodiments of the present invention can reduce various vibration frequencies of the engine as well as actively reduce vibration in the engine by adjusting a change in the air pressure of the pneumatic chamber A.

For convenience in explanation and accurate definition in the appended claims, the terms “upper”, and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine mount comprising:
a main rubber and a diaphragm coupled with an upper portion and a lower portion of a tubular body, respectively, to define a first inner space in which working fluid is encapsulated;
upper and lower orifice plates coupled with each other to define a second inner space therein, the upper and lower orifices being disposed in the first inner space and connected to the tubular body to define an upper fluid chamber between the main rubber and the upper orifice plate and defining a lower fluid chamber between the lower orifice plate and the diaphragm;
a pneumatic plate disposed inside the second inner space and dividing the second inner space into a middle fluid chamber in which the working fluid selectively communicates between the upper fluid chamber and the middle fluid chamber through a sub-orifice channel formed in the upper orifice plate, and a pneumatic chamber to which a pressure is applied to control a pressure therein; and
a main orifice channel formed in the upper and lower orifice plates and configured to allow fluid communication between the upper fluid chamber and the lower fluid chamber;
whereby inertial resistance of the working fluid passing through the main orifice and inertial resistance of the working fluid passing through the sub-orifice reduce vibration in an engine.

2. The engine mount according to claim 1, wherein the pneumatic plate is press-fitted into the upper orifice plate to form an assembly of the upper orifice plate and the pneumatic plate, which is in turn press-fitted into the lower orifice plate.

3. The engine mount according to claim 1, wherein the inertial resistance of the working fluid passing through the main orifice channel and the inertial resistance of the working fluid passing through the sub-orifice channel reduce different vibration frequencies of the engine.

4. The engine mount according to claim 3, wherein the pneumatic plate is press-fitted into the upper orifice plate to form an assembly of the upper orifice plate and the pneumatic plate, which is in turn press-fitted into the lower orifice plate.

5. The engine mount according to claim 1, further comprising a control device for controlling the pressure in the pneumatic chamber,
wherein the pneumatic plate is configured and dimensioned to be deformed in response to a change in the pressure of the pneumatic chamber caused by the control unit such that the working fluid is introduced to selectively communicate between the upper fluid chamber and the middle fluid chamber.

6. The engine mount according to claim 5, wherein the pneumatic plate is press-fitted into the upper orifice plate to form an assembly of the upper orifice plate and the pneumatic plate, which is in turn press-fitted into the lower orifice plate.

7. The engine mount according to claim 5, wherein the control unit comprises:
an air channel formed in the lower orifice plate, for allowing air to enter and exit the pneumatic chamber; and
a solenoid valve for opening and closing the air channel.

8. The engine mount according to claim 7, wherein the pneumatic plate is press-fitted into the upper orifice plate to form an assembly of the upper orifice plate and the pneumatic plate, which is in turn press-fitted into the lower orifice plate.

9. The engine mount according to claim 7, wherein the solenoid valve operates on a signal, received from an electronic control unit of the vehicle, in order to operate according to vibration states of the engine.
